(19) United States
(12) Patent Application Publication
(10) Pub. No.: US 2025/0192299 A1
(43) Pub. Date: Jun. 12, 2025

(54) TRACTION BATTERY PACK WITH FOLDED ENCLOSURE PIECE

(71) Applicant: Ford Global Technologies, LLC, Dearborn, MI (US)

(72) Inventors: John Peter Bilezikjian, Canton, MI (US); Derek Timothy Taylor, Waterford, MI (US); Nicholas Braeseker, Novi, MI (US)

(21) Appl. No.: 18/760,579

(22) Filed: Jul. 1, 2024

Related U.S. Application Data
(60) Provisional application No. 63/607,888, filed on Dec. 8, 2023.

(51) Int. Cl. H01M 50/238; H01M 50/224; H01M 50/242; H01M 50/249

(52) U.S. Cl. CPC H01M 50/238; H01M 50/224; H01M 50/242; H01M 50/249

(57) ABSTRACT

A traction battery pack assembly includes an enclosure assembly having a folded enclosure piece and at least one cell stack within an interior of the enclosure assembly. The folded enclosure piece includes a first section that is folded along an axis relative to a second section. The at least one cell stack has one or more battery cells.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure details exemplary traction battery pack enclosures and, more particularly, to an enclosure.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly can include at least one cell stack held within an enclosure assembly.

### SUMMARY

In some aspects, the techniques described herein relate to a traction battery pack assembly, including: an enclosure assembly having a folded enclosure piece having a first section that is folded along an axis relative to a second section; and at least one cell stack within an interior of the enclosure assembly, the at least one cell stack having one or more battery cells.

In some aspects, the techniques described herein relate to a traction battery pack assembly, further including a plate of the enclosure assembly, the at least one cell stack disposed on the plate.

In some aspects, the techniques described herein relate to a traction battery pack assembly, wherein the plate is a skid plate.

In some aspects, the techniques described herein relate to a traction battery pack assembly, wherein the plate is planar.

In some aspects, the techniques described herein relate to a traction battery pack assembly, wherein the folded enclosure piece is adhesively secured to the plate.

In some aspects, the techniques described herein relate to a traction battery pack assembly, wherein the folded enclosure piece provides a channel that receives the at least one cell stack.

In some aspects, the techniques described herein relate to a traction battery pack assembly, further including a first cover and a second cover of the enclosure assembly, the first cover covering a first end of the channel, the second cover covering an opposite, second end of the channel.

In some aspects, the techniques described herein relate to a traction battery pack assembly, further including at least one connection interface of the first cover, the second cover, or both.

In some aspects, the techniques described herein relate to a traction battery pack assembly, wherein the plate is a skid plate.

In some aspects, the techniques described herein relate to a traction battery pack assembly, wherein the folded enclosure piece is a metal or metal alloy.

In some aspects, the techniques described herein relate to a traction battery pack assembly, wherein the axis is a first axis and the first section is disposed along a first side of the second section, and further including a third section that is folded along a second axis relative to the second section and is disposed along an opposite side of the second section.

In some aspects, the techniques described herein relate to a traction battery pack assembly, wherein the first axis and the second axis are parallel to each other.

In some aspects, the techniques described herein relate to a traction battery pack assembly, wherein the first section and the second section are parallel to each other.

In some aspects, the techniques described herein relate to a traction battery pack assembly, further including a plate of the enclosure assembly, the at least one cell stack disposed on the plate, wherein the first section and the third section each include a lip that attaches to the plate.

In some aspects, the techniques described herein relate to a traction battery pack assembly, wherein the folded enclosure piece is U-shaped.

In some aspects, the techniques described herein relate to a traction battery pack cell stack enclosing method, including: folding a first section of a sheet of material about an axis relative to a second section of the sheet of material to provide a folded enclosure piece; and using the first section and the second section to enclose at least one cell stack.

In some aspects, the techniques described herein relate to a method, further including folding a third section of the folded enclosure piece relative to the first section to establish a channel in the folded enclosure piece.

In some aspects, the techniques described herein relate to a method, further including positioning the at least one cell stack within the channel in the folded enclosure piece.

In some aspects, the techniques described herein relate to a method, further including supporting the at least one cell stack directly on a skid plate, and securing the folded enclosure piece directly to the skid plate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1 having an enclosure assembly with a folded enclosure piece.

FIG. 3 illustrates an expanded view of the battery pack of FIG. 2.

FIGS. 4-7 illustrate perspective views of a sheet of material being folded into the folded enclosure piece.

FIG. 8 illustrates a perspective view of an enclosure assembly according to another exemplary aspect of the present disclosure.

### DETAILED DESCRIPTION

A battery pack can include at least one cell stack housed within an enclosure assembly. To provide the enclosure assembly, multiple enclosure pieces can be joined together.

This disclosure is directed toward enclosure pieces that are folded to provide areas that accommodate the at least one cell stack. Enclosure pieces that are folded can provide more area for accommodating the at least one cell stack than enclosure pieces that are, for example, deep drawn. Pieces that are deep drawn can require a larger corner radius than pieces that are folded

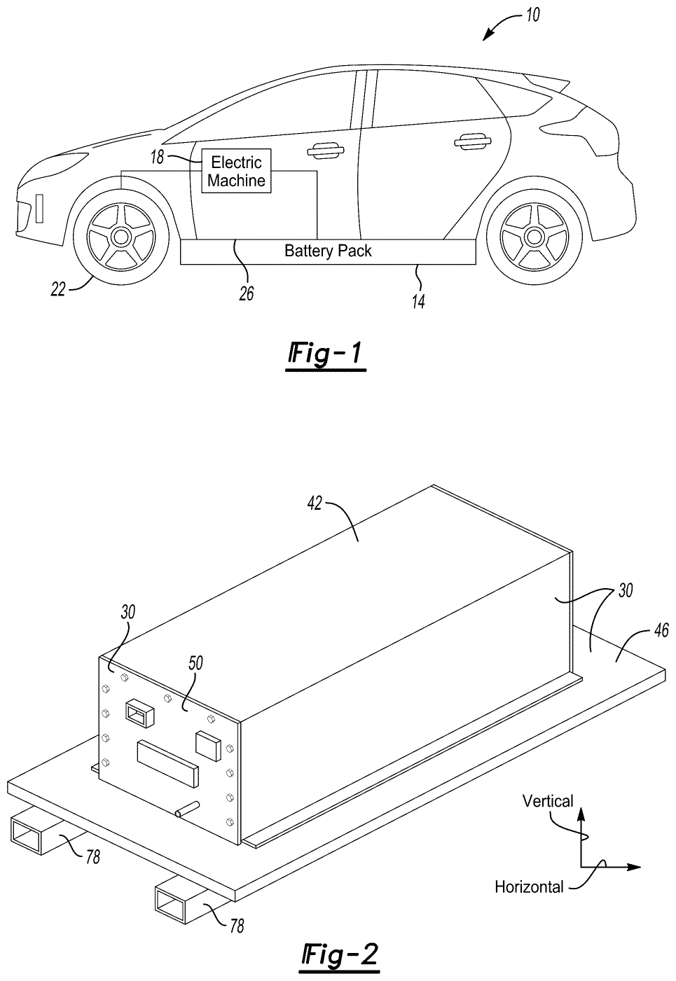

With reference to FIG. 1, an electrified vehicle 10 includes a traction battery pack 14, an electric machine 18, and wheels 22. The traction battery pack 14 powers the electric machine 18, which can convert electrical power to mechanical power to drive the wheels 22.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

The traction battery pack 14 is, in the exemplary embodiment, secured to an underbody 26 of the electrified vehicle 10. The traction battery pack 14 could be located elsewhere on the electrified vehicle 10 in other examples.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

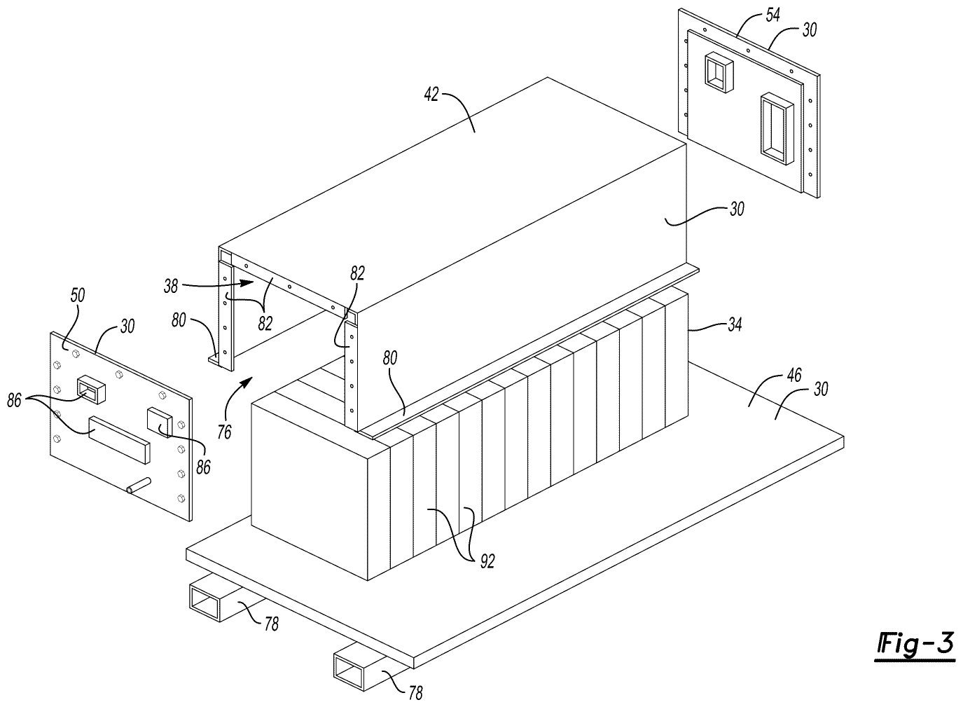

Referring now to FIGS. 2 and 3, the battery pack 14 includes an enclosure assembly 30 and at least one cell stack 34. The example enclosure assembly 30 includes a plurality of enclosure pieces that cooperate to enclose the at least one cell stack 34 within an interior 38 of the enclosure assembly 30.

In the exemplary embodiment, the enclosure assembly 30 includes a folded enclosure piece 42, a plate 46, a first cover 50, and a second cover 54. The folded enclosure piece 42 is disposed vertically above the plate 46. Vertical, for purposes of this disclosure, is with reference to ground and a general orientation of the vehicle 10 and the battery pack 14 during operation.

Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

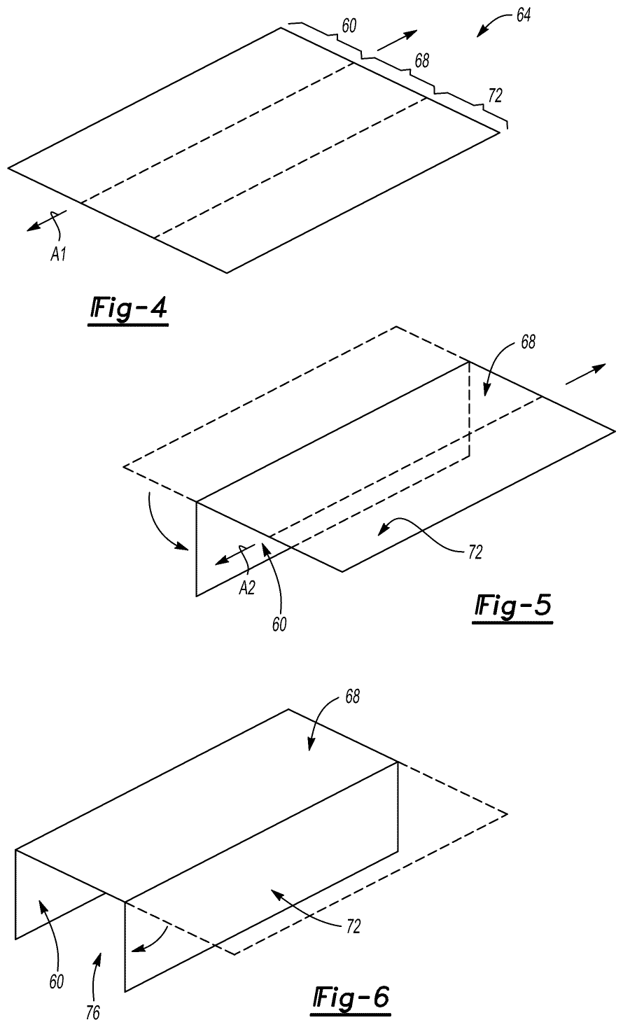

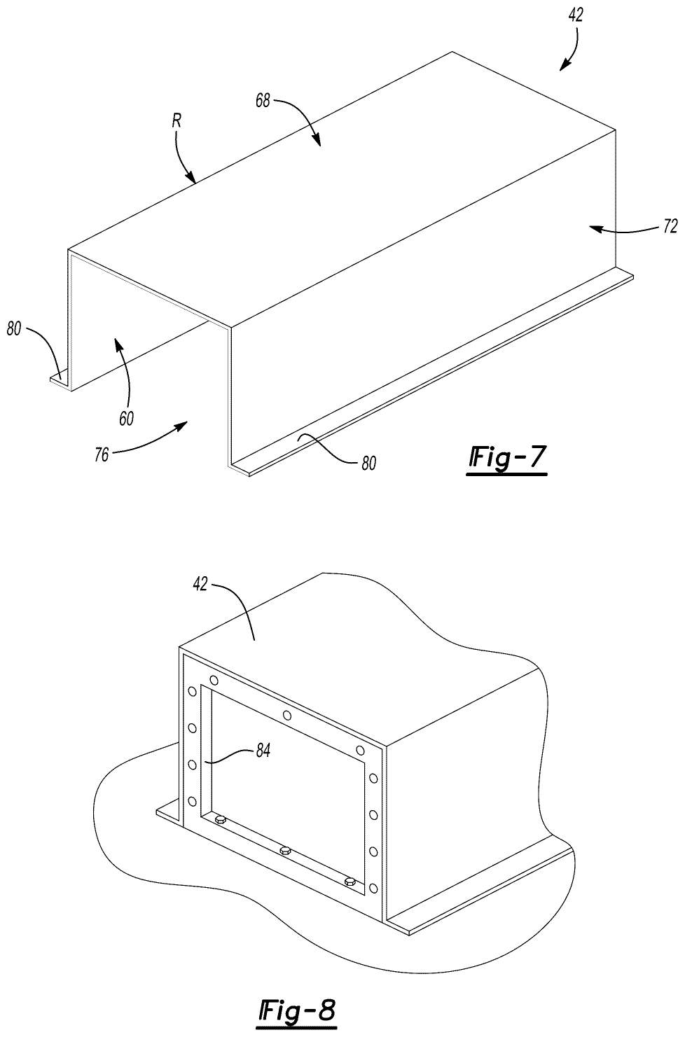

With reference now to FIGS. 4 to 7 and continuing reference to FIGS. 2 and 3, the folded enclosure piece 42 is provided by bending a first section 60 of a sheet of material 64 relative to a second section 68 of the sheet of material 64. The bending of the first section 60 is a bending about a first axis A1. Tooling, such as bending machines, can be used to fold the first section 60 relative to the second section 64. A person having skill in this art and the benefit of this disclosure could understand how to use tooling to bend a sheet of material.

The sheet of material 64 is a metal or metal alloy, such as sheet metal. The sheet of material 64 is planar.

In the exemplary embodiment, a third section 72 of the sheet of material 64 is bent relative to the second section 68 about a second axis A2. The third section 72 and the first section 60 then extend parallel to each other from opposing sides of the second section 68 to provide a channel 76. End portions of the first section 60 and the third section 72 can then be bent to provide lips 80.

A person having skill in this art would understand how to structurally distinguish a folded component from a component that is not folded. Thus, specifying that the folded enclosure piece 42 is a folded enclosure piece 42 implicates structure to the enclosure piece and structurally distinguishes the folded enclosure piece 42 from an enclosure piece that is not folded such as a deep-drawn enclosure piece, or a cast enclosure piece.

The first axis A1 and the second axis A2 are parallel to each other in this example. The first section 60 and the third section 72 are disposed are also parallel to each other, and are perpendicular to the second section 68.

The folded enclosure piece 42 is U-shaped. A radius R between the first section 60 and the second section 68 is smaller than the radius that would be required to form a deep-drawn channel. Similarly, a radius between the second section 68 and the third section 72 is smaller than the radius that would be required to form a deep-drawn channel

The plate 46 is a skid plate in this example. The plate 46 is planar and is not folded. The plate 46, in this example, provides no recessed area that receives the cell stack 34. The cell stack 34 is disposed upon a planar top surface of the plate 46 with the plate 46 is directly supporting the cell stack 34. The plate 46 can be secured to structural members of the vehicle 10, such as side rails 78 of the vehicle 10.

The folded enclosure piece 42 can be placed over the cell stack 34, which positions the cell stack 34 within the channel 76. The folded enclosure piece 42, particularly the second section 68 can be adhesively secured to a top side of the cell stack 34 to, among other things, help stiffen the battery pack 14.

The folded enclosure piece 42 can be attached to the plate 46 through the lips 80. Mechanical fasteners, adhesive, or both can be used to secure the folded enclosure piece 42 to the plate 46. Seals can be incorporated between the lips 80 and the plate 46 to seal interfaces between the lips 80 and the plate 46.

The first cover 50 and the second cover 54 can be installed to opposite ends of the channel 76 to enclosure the cell stack 34 within the interior 38. The first cover 50 and the second cover 54 can each be secured to flanges 82 of the folded enclosure piece 42. The first cover 50 and the second cover 54 could be secured using mechanical fasteners (e.g., clips, bolts), adhesive, or both. Interfaces between the first cover 50 and the other components can be sealed, as can interfaces between the second cover 54 and the other components. The seal can be a foam seal in some examples. Accessing the components within the interior 38 for service can be accomplished by removing the first cover 50 or the second cover 54.

In another example, as shown in FIG. 8, the first cover 50 and the second cover 54 could instead or additionally be secured to a hoop-shaped bracket 84 that is separate from the folded enclosure piece 42. The hoop-shaped bracket 84 could be pre-installed to either the folded enclosure piece 42 or to plate 46.

Referring again to FIGS. 2-7, the first cover 50, the second cover 54, or both can include various connection interfaces 86, such as electronic headers/modules and coolant ports. The connection interfaces provide interfaces for coupling the battery pack 14 to other portions of the vehicle 10. Coolant, for example, can be circulated into the interior 38 through ports in the first cover 50.

In this disclosure, the at least one cell stack 34 having one or more individual battery cells 92 disposed along a cell stack axis A. The cell stack 34 could include any number of battery cells 92. Further, the battery pack 14 could employ any number of cell stacks 34 within the enclosure assembly 30. Thus, this disclosure is not limited to the exact configuration shown.

In an embodiment, the battery cells 92 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly having a folded enclosure piece, the folded enclosure piece including a first section that is folded along an axis relative to a second section; and
at least one cell stack within an interior of the enclosure assembly, the at least one cell stack having one or more battery cells.

2. The traction battery pack assembly of claim 1, further comprising a plate of the enclosure assembly, the at least one cell stack disposed on the plate.

3. The traction battery pack assembly of claim 2, wherein the plate is a skid plate.

4. The traction battery pack assembly of claim 2, wherein the plate is planar.

5. The traction battery pack assembly of claim 2, wherein the folded enclosure piece is adhesively secured to the plate.

6. The traction battery pack assembly of claim 2, wherein the folded enclosure piece provides a channel that receives the at least one cell stack.

7. The traction battery pack assembly of claim 6, further comprising a first cover and a second cover of the enclosure assembly, the first cover covering a first end of the channel, the second cover covering an opposite, second end of the channel.

8. The traction battery pack assembly of claim 7, further comprising at least one connection interface of the first cover, the second cover, or both.

9. The traction battery pack assembly of claim 7, wherein the plate is a skid plate.

10. The traction battery pack assembly of claim 1, wherein the folded enclosure piece is a metal or metal alloy.

11. The traction battery pack assembly of claim 1, wherein the axis is a first axis and the first section is disposed along a first side of the second section, and further comprising a third section that is folded along a second axis relative to the second section and is disposed along an opposite side of the second section.

12. The traction battery pack assembly of claim 11, wherein the first axis and the second axis are parallel to each other.

13. The traction battery pack assembly of claim 11, wherein the first section and the second section are parallel to each other.

14. The traction battery pack assembly of claim 11, further comprising a plate of the enclosure assembly, the at least one cell stack disposed on the plate, wherein the first section and the third section each include a lip that attaches to the plate.

15. The traction battery pack assembly of claim 11, wherein the folded enclosure piece is U-shaped.

16. A traction battery pack cell stack enclosing method, comprising:
folding a first section of a sheet of material about an axis relative to a second section of the sheet of material to provide a folded enclosure piece; and
using the first section and the second section to enclose at least one cell stack.

17. The method of claim 16, further comprising folding a third section of the folded enclosure piece relative to the first section to establish a channel in the folded enclosure piece.

18. The method of claim 17, further comprising positioning the at least one cell stack within the channel in the folded enclosure piece.

19. The method of claim of claim 18, further comprising supporting the at least one cell stack directly on a skid plate, and securing the folded enclosure piece directly to the skid plate.
